(19) United States
(12) Patent Application Publication
(10) Pub. No.: US 2002/0049829 A1
(43) Pub. Date: Apr. 25, 2002

(54) Data distribution system

(76) Inventor: Hiroshi Miyawaki, Ehime (JP)

Correspondence Address: WENDEROTH, LIND & PONACK, L.L.P., 2033 K STREET N. W., SUITE 800, WASHINGTON, DC, 20006-1021, US

(21) Appl. No.: 09/982,026

(22) Filed: Oct. 19, 2001

(30) Foreign Application Priority Data
Oct. 19, 2000 (JP) 2000-319882

(51) Int. Cl. G06F 15/16

(52) U.S. Cl. 709/217

(57) ABSTRACT

The present invention provides a data distribution system which enables distribution of data suitable for specifications of an information terminal from an information provider apparatus, and can carry out an appropriate charging process for the distributed data. This data distribution system comprises an information terminal which automatically transmits specifications of the information terminal when transmitting an information provision request which requests distribution of information, and an information provider apparatus which receives the information provision request and the information terminal specifications from the information terminal, converts data corresponding to the received information provision request so as to conform to the specifications of the information terminal, and transmits the converted data to the information terminal, as well as decides the amount of charges according to the contents of the data transmitted to the information terminal, and charges the information user.

### FIELD OF THE INVENTION

The present invention relates to a data distribution system and, more particularly, to a data distribution system which can distribute image or music data of a quality level that is optimum for specifications of an information terminal used by an information user.

### BACKGROUND OF THE INVENTION

In recent years, various kinds of information such as image data and music data can be easily obtained via the Internet. Conventionally, as common means for obtaining these image data or music data, image servers or music servers are accessed from a personal computer to download data, and thereafter the downloaded data are reproduced. However, recently, information terminals which reproduce data which are downloaded by logging on networks as they are have been developed successively, and specifications of the information terminals of information users have been more diversified.

For example, as examples of the information terminals which receive and reproduce image or music data distributed on the Internet, there are Internet radios which log on the Internet via telephone lines to access radio stations all over the world and reproduce voices or music, printers which log on the Internet via intracompany local area networks to access still-picture data of high resolution on large screens and directly print the still pictures, Internet televisions which log on the Internet via cable modems to access plural moving picture servers and reproduce moving pictures, and the like.

However, the respective servers retain the image or music data distributed via the Internet in diverse data formats. These data formats do not always conform to the specifications of the information terminals used by the information users.

Further, the specifications of the information terminals used by the information users are also diversified, and therefore formats of data transmitted from the servers may not conform to the specifications of the information terminals which reproduce the data, whereby the data cannot be reproduced.

Accordingly, to address the diversification of the reproduction functions of the information terminals, part of image or music data providers suggest a system in which image or music data of plural different data formats are retained on the server ends and data are provided according to the specifications of the information terminals used by the information users.

Further, in Japanese Published Patent Application No. Hei.6-223122 or No. Hei.9-181910, systems are disclosed in which data formats are converted on the server ends so as to conform to specifications of an information terminal designated by an information user, and thereafter the data are distributed and charged.

However, in the above-mentioned systems, the specification of the information terminal should be designated every time the information user downloads data, resulting in great troubles.

Further, the information user should always correctly remember the functions or specifications of the information terminal to be used and correctly input the same, and besides although the information user utilizes the same information terminal to access the same server, the same contents should be inputted again and again.

Further, when the information user does not designate the specifications of the information terminal or erroneously inputs the same, image data or music data of a higher quality level, which cannot be reproduced by that information terminal, may be transmitted and accordingly more charges than required should be paid. Or image data or music data of a lower quality level which is below the reproduction ability of the information terminal may be transmitted and thus the functions of the information terminal cannot be sufficiently utilized.

Furthermore, when an information user uses plural information terminals, although the information user has already downloaded image data or music data with one information terminal and charged, when the information user downloads the same data again using another information terminal, the user is always charged additionally.

### SUMMARY OF THE INVENTION

The present invention has for its object to provide a data distribution system which can distribute image or music data which is suitable for specifications of an information terminal from a server end when distribution of the image or music data is requested by an information user using the information terminal, without the need of inputting and transmitting the specifications of the information terminal each time, as well as can charge each information user according to the contents of the distributed data.

Other objects and advantages of the present invention will become apparent from the detailed description and specific embodiments described are provided only for illustration since various additions and modifications within the spirit and scope of the invention will be apparent to those of skill in the art from the detailed description.

According to a 1st aspect of the present invention, there is provided a data distribution system which comprises an information terminal for requesting distribution of information and an information provider apparatus for providing information to the information terminal, comprising: the information terminal automatically transmitting specifications of the information terminal when transmitting an information provision request which requests distribution of information; and the information provider apparatus including: a receiving unit for receiving the information provision request and the information terminal specifications transmitted from the information terminal; a data storage unit for storing and managing various kinds of information data; a data detection unit for detecting data corresponding to the information provision request received by the receiving unit from the data storage unit; a data conversion unit for converting the data detected by the data detection unit so as to conform to the information terminal specifications received by the receiving unit; and a transmission unit for transmitting the data converted by the data conversion unit to the information terminal.

According to a 2nd aspect of the present invention, there is provided a data distribution system which comprises an information terminal for requesting distribution of information and an information provider apparatus for providing information to the information terminal, comprising: the information terminal automatically transmitting an information terminal ID of the information terminal when transmitting an information provision request which requests distribution of information; and the information provider apparatus including: an information terminal database for storing and managing the information terminal ID and specifications of the information terminal in pair; a receiving unit for receiving the information provision request and the information terminal ID transmitted from the information terminal and detecting specifications of the information terminal, corresponding to the information terminal ID, from the information terminal database; a data storage unit for storing and managing various kinds of information data; a data detection unit for detecting data corresponding to the information provision request received by the receiving unit from the data storage unit; a data conversion unit for converting the data detected by the data detection unit so as to conform to the information terminal specifications received by the receiving unit; and a transmission unit for transmitting the data converted by the data conversion unit to the information terminal.

According to a 3rd aspect of the present invention, in the data distribution system of the 1st aspect, the information provider apparatus further includes a charge management unit for deciding an amount of charges according to contents of data transmitted to the information terminal and charging an information user.

According to a 4th aspect of the present invention, in the data distribution system of the 2nd aspect, the information provider apparatus further includes a charge management unit for deciding an amount of charges according to contents of data transmitted to the information terminal and charging an information user.

According to a 5th aspect of the present invention, in the data distribution system of the 3rd aspect, the information provider apparatus further includes a client database for storing and managing utilization histories of information users, and the charge management unit decides an amount of charges according to utilization history of an information user, stored in the client database, and contents of data transmitted to the information terminal, and charges the information user.

According to a 6th aspect of the present invention, in the data distribution system of the 4th aspect, the information provider apparatus further includes a client database for storing and managing utilization histories of information users, and the charge management unit decides an amount of charges according to utilization history of an information user, stored in the client database, and contents of data transmitted to the information terminal, and charges the information user.

According to a 7th aspect of the present invention, in the data distribution system of any of the 1st to 6th aspects, when a target for the information provision request transmitted from the information terminal to the information provider apparatus is still picture data, the specifications of the information terminal include information of at least one selected from a number of pixels, a tone, a compression ratio, a compression method, a number of reproducible pictures, and a storage capacity.

According to an 8th aspect of the present invention, in the data distribution system of any of the 1st to 6th aspects, when a target for the information provision request transmitted from the information terminal to the information provider apparatus is moving picture data, the specifications of the information terminal include information of at least one selected from a number of pixels, a tone, a compression ratio, a compression method, a reproduction time, and a storage capacity.

According to a 9th aspect of the present invention, in the data distribution system of any of the 1st to 6th aspects, when a target for the information provision request transmitted from the information terminal to the information provider apparatus is audio data, the specifications of the information terminal include information of at least one selected from a sampling rate, a frequency band, a compression ratio, a compression method, a reproduction time, and a storage capacity.

### BRIEF DESCRIPTION OF THE DRAWINGS

FIG. 1 is a block diagram illustrating an example of a data distribution system according to a first embodiment of the present invention.

FIG. 2 is a flowchart for explaining an example of an operation of an information provider apparatus in the data distribution system of the first embodiment.

FIG. 3 is a diagram showing an example of specifications of an information terminal.

FIG. 4 is a diagram showing an example of data stored in a charge database of the information provider apparatus according to the first embodiment.

FIG. 5 is a block diagram illustrating an example of a data distribution system according to a second embodiment of the present invention.

FIG. 6 is a diagram showing an example of data stored in an information terminal database of an information provider apparatus according to the second embodiment.

FIG. 7 is a flowchart for explaining an example of the operation of the information provider apparatus in the data distribution system of the second embodiment.

FIG. 8 is a block diagram illustrating an example of a data distribution system according to a third embodiment of the present invention.

FIG. 9 is a flowchart for explaining an example of an operation of an information provider apparatus in the data distribution system of the third embodiment.

FIG. 10 is a flowchart for explaining an example of a charging process of an information management apparatus in the data distribution system of the third embodiment.

FIG. 11 is a diagram showing an example of data stored in a client database of the information provider apparatus of the third embodiment.

### DETAILED DESCRIPTION OF THE PREFERRED EMBODIMENTS

Hereinafter, data distribution systems according to the present invention will be described with reference to figures. The embodiments shown here are only exemplary and the present invention is not restricted to these embodiments.

[Embodiment 1]

A data distribution system according to a first embodiment of the present invention automatically transmits specifications of information terminals from the information terminals to a data conversion server, thereby enabling distribution of image or music data of a quality level which is optimum for an information terminal used by an information user.

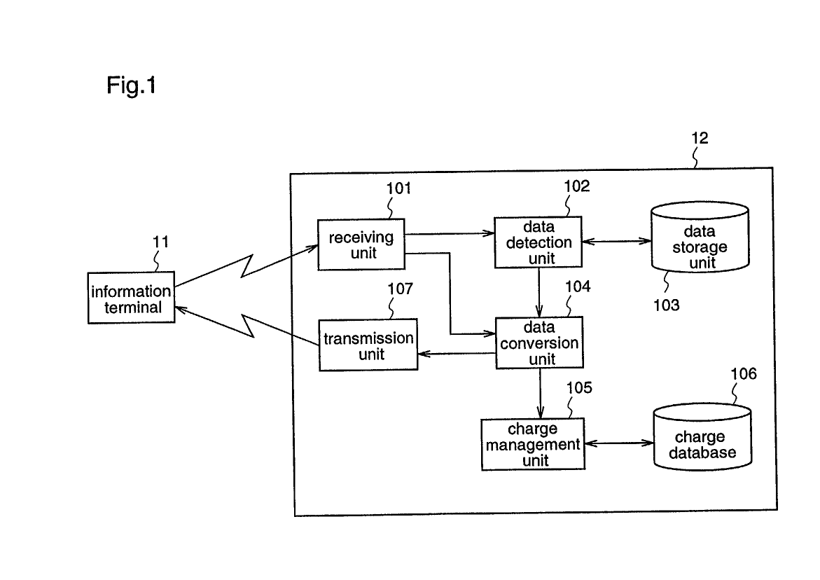

Hereinafter, the data distribution system of the first embodiment will be described in more detail with reference to FIGS. 1 to 4.

FIG. 1 is a block diagram illustrating an example of the data distribution system according to the first embodiment.

In FIG. 1, the data distribution system comprises an information terminal 11 used by an information user and an information provider apparatus 12 for distributing information to the information user.

The information terminal 11 can log on the information provider apparatus 12 through a communication line, and it makes an information provision request which requests the information provider apparatus 12 to distribute information such as music or image data, as well as automatically transmits specifications of the information terminal 11 to the information provider apparatus 12. Further, when the requested information such as image or music data is distributed from the information provider apparatus 12, the information terminal 11 receives the data.

Here, the communication line includes not only common telephone lines but also various special lines and ISDN lines.

The specifications of the information terminal represent the format of data requested by the information terminal 11. When still picture information is requested, the specifications include information such as the number of pixels, the tone, the compression ratio, the compression method, the number of reproducible pictures, the storage capacity. When moving picture information is requested, the specifications include information such as the number or pixels, the tone, the compression ratio, the compression method, the reproduction time, the storage capacity. Further, when audio information is requested, information such as the sampling rate, the frequency band, the compression ratio, the compression method is included.

These specifications of the information terminal are previously stored in a memory (not shown) of the information terminal and automatically transmitted to the information provider apparatus 12 when the information provision request is transmitted.

The information provider apparatus 12 comprises a receiving unit 101, a data detection unit 102, a data storage unit 103, a data conversion unit 104, a charge management unit 105, a charge database 106 and a transmission unit 107.

The receiving unit 101 receives the information provision request and the information terminal specifications which are transmitted from the information terminal 11, and outputs the information provision request to the data detection unit 102 and the information terminal specifications to the data conversion unit 104, respectively.

The data detection unit 102 receives the information provision request, detects data corresponding to the information provision request from the data storage unit 103, and outputs the detected data to the data conversion unit 104.

The data storage unit 103 stores and manages various kinds of information data.

The data conversion unit 104 converts the data corresponding to the information provision request, outputted from the data detection unit 102, into a data format according to the information terminal specifications received by the receiving unit 101, and outputs the converted data to the transmission unit 107 as well as outputs charge information to the charge management unit 105, which information is information relating to the contents of the data to be transmitted to the information terminal 11, such as the type of pre-conversion data, the amount of the data, the format of post-conversion data and the date of utilization, and is used for deciding the amount of charges.

The charge management unit 105 decides the amount of charges on the basis of the charge information outputted from the data conversion unit 104 with using a charge data table stored in the charge database 106, and collects charges from the user who uses the information terminal 11 by using a method such as electronic payment.

The transmission unit 107 transmits the data which has been converted by the data conversion unit 104 into the data format depending on the specifications of the information terminal, to the information terminal 11. The transmission unit 107 may have a structure which simultaneously notifies the user of the amount of charges decided by the charge management unit 105.

Next, the operation of the data distribution system will be described.

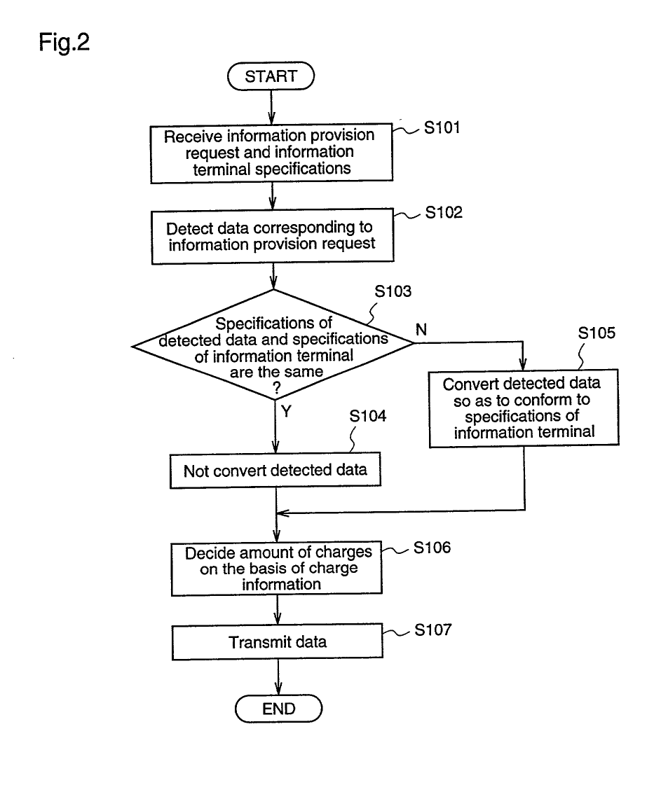

Hereinafter, the operation of the information provider apparatus 12, which is started by transmission of an information provision request and information terminal specifications from the information terminal 11, will be described with reference to FIG. 2.

FIG. 2 is a flowchart for explaining an example of the operation of the information provider apparatus in the data distribution system according to the first embodiment.

The receiving unit 101 receives an information provision request and information terminal specifications from the information terminal 11. At this time, the information provision request transmitted from the information terminal 11 is outputted to the data detection unit 102, and the information terminal specifications are outputted to the data conversion unit 104, respectively.

The data detection unit 102 retrieves data corresponding to the information provision request from the data storage unit 103 on the basis of the information provision request transmitted from the information terminal 11, and outputs the retrieved data corresponding to the information provision request to the data conversion unit 104.

The data conversion unit 104 judges whether the format of the data detected by the data detection unit 102 conforms to the information terminal specifications received by the receiving unit 101, with using the data detected by the data detection unit 102 and the information terminal specifications received by the receiving unit 101. Consequently, when the format conforms to the specifications of the information terminal the operation proceeds to step S104, and when the format does not conform to the specifications the operation proceeds to step S105.

When the format of the detected data conforms to the specifications of the information terminal, the data conversion unit 104 outputs the data as it is to the transmission unit 107, as well as outputs charge information, which is information concerning the contents of the data to be transmitted to the information terminal 11, to the charge management unit 105.

When the format of the detected data does not conform to the specifications of the information terminal, the data conversion unit 104 converts the data into a data format which conforms to the specifications of the information terminal, and outputs the converted data to the transmission unit 107 as well as outputs the charge information, which is information concerning the contents of the data to be transmitted to the information terminal 11, to the charge management unit 105.

The charge management unit 105 decides the amount of charges using a charge data table stored in the charge database 106, on the basis of the charge information outputted from the data conversion unit 104, which is information concerning the contents of the data to be transmitted to the information terminal 11. The decided amount of charges is collected from the user of the information terminal 11 as the information user, with using a method such as electronic payment.

The transmission unit 107 transmits the data outputted from the data conversion unit 104, conforming to the specifications of the information terminal, to the information terminal 11, and ends the processing.

Next, a method for deciding the amount of charges by the charge management unit 105 in the information provider apparatus 12 will be described in detail with reference to FIGS. 1, 3 and 4.

When the charge information as information concerning the contents of the data to be transmitted to the information terminal 11 is outputted from the data conversion unit 104, the charge management unit 105 decides the amount of charges using the charge data table stored in the charge database 106.

Here, a description will be given of a case where the charge information is composed of the type of pre-conversion data and the format of post-conversion data, and the amount of charges is decided on the basis of the charge information with using the charge data table stored in the charge database 106.

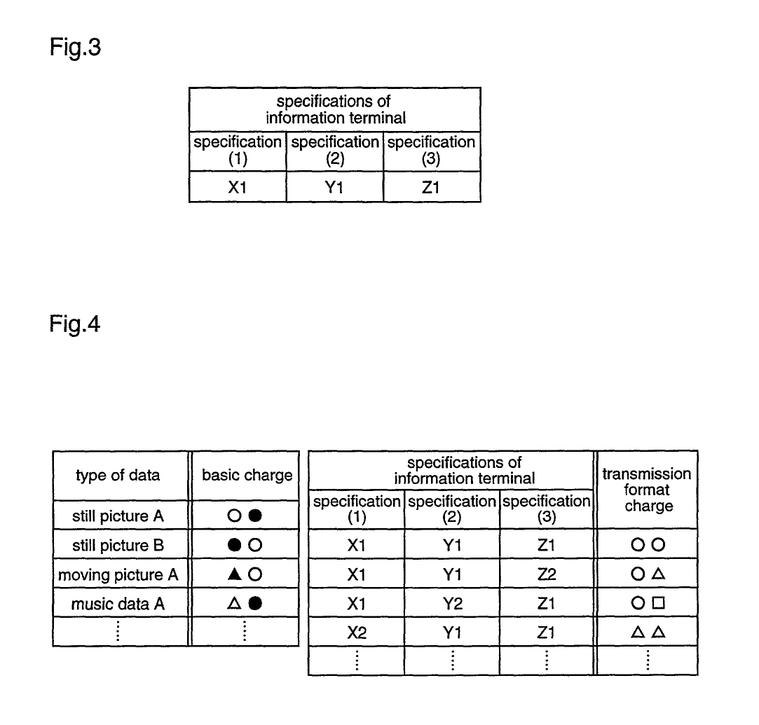

For example, when the specifications of the information terminal as shown in FIG. 3 are transmitted to the information provider apparatus 12 together with an information provision request which requests a still picture A, charge information indicating that the type of pre-conversion data is the still picture A and that the format of post-conversion data is under the specifications of the information terminal shown in FIG. 3 is outputted from the data conversion unit 104 to the charge management unit 105.

FIG. 4 is a diagram showing an example of the charge data table stored in the charge database 106 of the information provider apparatus 12. The charge management unit 105 decides a basic charge for the type of data to be transmitted and a transmission format charge which depends on the data format of the data, on the basis of the charge data table shown in FIG. 4, and adds the basic charge and the transmission format charge to obtain the amount of charges.

More specifically, the amount of charges is obtained by adding a basic charge corresponding to the still picture A and a transmission format charge corresponding to the specifications of the information terminal shown in FIG. 3.

It is unnecessary that the transmission format charge should be always a positive value. For example, when data is converted into an image of a lower quality, the amount of data to be transmitted is reduced as compared to the pre-conversion data. Accordingly, the transmission format charge of a negative value can be set and the amount of charges in this case is a value lower than the basic charge.

Thereafter, the charge management unit 105 collects the amount of charges from the user who uses the information terminal with using a method such as electronic payment.

As described above, according to the data distribution system of the first embodiment, specifications of an information terminal are automatically transmitted together with an information provision request for an information provider apparatus. Therefore, the information provider apparatus can transmit image data or music data which conform to the specifications of the information terminal, as well as the information terminal can receive image data or music data of an optimum data format, whereby excessive data or the like which cannot be reproduced by the information terminal are not transmitted. Further, the information provider apparatus decides the amount of charges according to the format of data transmitted to the information terminal, whereby the information user is charged properly.

[Embodiment 2]

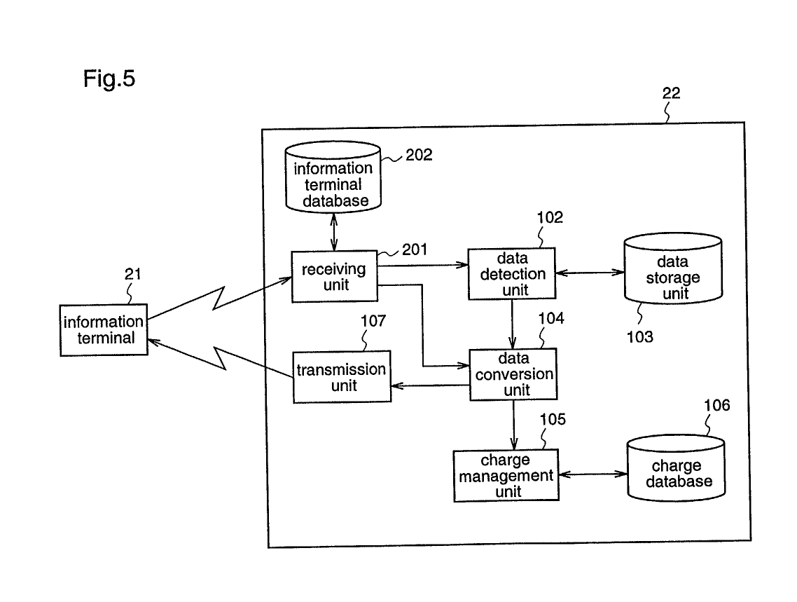

Hereinafter, a data distribution system according to a second embodiment of the present invention will be described with reference to FIGS. 5 to 7.

FIG. 5 is a block diagram illustrating the data distribution system according to the second embodiment. The data distribution system of the second embodiment is different from that of the first embodiment only in that an information terminal database 202 for storing and managing specifications of an information terminal is included in an information provider apparatus 22 and the information terminal specifications are not transmitted from the information terminal 21 when the specifications of the information terminal are stored in the information terminal database 202. The same reference numerals as those in the first embodiment denote the same components.

In FIG. 5, the data distribution system comprises an information terminal 21 used by an information user, and an information provider apparatus 22 which distributes information to the information user.

The information terminal 21 can log on the information provider apparatus 22 via a communication line. The information terminal 21 makes an information provision request which requests the information provider apparatus 22 to distribute information such as music data or image data, as well as automatically transmits an information terminal ID of the information terminal 21. At this time, when information terminal specifications corresponding to the information terminal ID of the information terminal 21 are not registered in the information terminal database 202 in the information provider apparatus 22, a specification transmission command is issued from the information provider apparatus 22, and then the information terminal 21 automatically transmits the specifications of the information terminal 21 to the information provider apparatus 22 another time. Further, when requested information such as image data and music data is distributed from the information provider apparatus 22, the information terminal 21 receives the data.

Here, the communication line includes not only common telephone lines but also various special lines, ISDN lines and the like.

The specifications of the information terminal represent the format of data requested by the information terminal 21. When still picture information is requested, the specifications include information such as the number of pixels, the tone, the compression ratio, the compression method, the number of reproducible pictures, the storage capacity. When moving picture information is requested, information such as the number of pixels, the tone, the compression ratio, the compression method, the reproduction time, the storage capacity is included. When audio information is requested, information such as the sampling rate, the frequency band, the compression ratio, the compression method is included.

The specifications and the information terminal ID of the information terminal are previously stored in a memory (not shown) included in the information terminal 21, and transmitted to the information provider apparatus 22 as required.

The information provider apparatus 22 comprises a receiving unit 201, a data detection unit 102, a data storage unit 103, a data conversion unit 104, a charge management unit 105, a charge database 106, a transmission unit 107 and an information terminal database 202.

The receiving unit 201 receives an information provision request and outputs the request to the data detection unit 102, as well as receives an information terminal ID transmitted from the information terminal 21 and checks whether information terminal specifications corresponding to the information terminal ID are included in data which are composed of information terminal IDs and information terminal specifications in pair, which data are stored and managed in the information terminal database 202.

When the information terminal specifications corresponding to the information terminal ID are not included, the receiving unit issues a specification transmission command to the information terminal 21, receives the information terminal specifications transmitted from the information terminal 21, and outputs the specifications to the data conversion unit 104. On the other hand, when the information terminal specifications corresponding to the information terminal ID are included, these information terminal specifications are outputted to the data conversion unit 104.

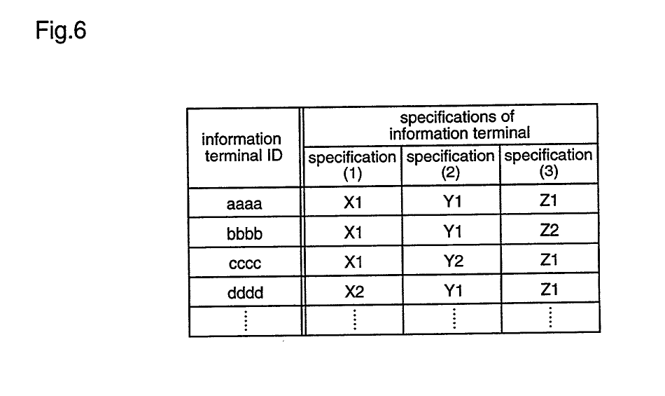

The information terminal database 202 stores and manages the information terminal IDs and the information terminal specifications in pair, as shown in FIG. 6. In this second embodiment, when the information terminal specifications are newly transmitted from the information terminal 21, these information terminal IDs and information terminal specifications are automatically registered. At the next access by the information terminal 21, the specifications of the information terminal 21 are decided on the basis of the registered information terminal ID and information terminal specifications. Here, the information terminal ID and the information terminal specifications may be previously registered for example when the information user subscribes to the data distribution system according to the present invention.

Next, the operation of the data distribution system will be described.

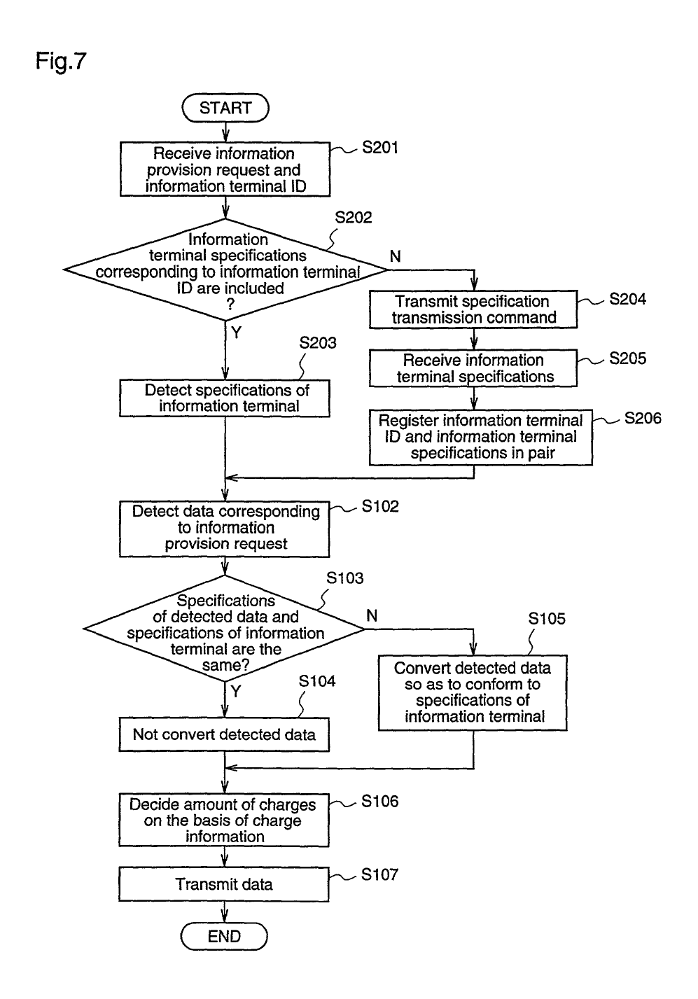

Hereinafter, the operation of the information provider apparatus, which is started by transmission of an information provision request and an information terminal ID from the information terminal 21, will be described with reference to FIG. 7.

FIG. 7 is a flowchart for explaining an example of the operation of the information provider apparatus in the data distribution system according to the second embodiment.

The receiving unit 201 receives an information provision request and an information ID transmitted from the information terminal 21.

Thereafter, the receiving unit 201 outputs the information provision request to the data detection unit 102 as well as checks whether information terminal specifications corresponding to the received information terminal ID are stored in the information terminal database 202. At this time, when the information terminal specifications corresponding to the information terminal ID are stored, the operation proceeds to step S203. When the specifications are not stored, the operation proceeds to step S204.

When the information terminal specifications corresponding to the information terminal ID are stored, these information terminal specifications are detected and outputted to the data conversion unit 104.

When the information terminal specifications corresponding to the information terminal ID are not stored, the receiving unit 201 transmits a specification transmission command to the information terminal 21 via the transmission unit 107, and requests the information terminal 21 to transmit the specifications of the information terminal.

At this time, when receiving the specification transmission command from the information provider apparatus 22, the information terminal 21 automatically transmits the specifications of the information terminal to the information provider apparatus 22.

The receiving unit 201 receives the information terminal specifications transmitted from the information terminal 21, and outputs these information terminal specifications to the data conversion unit 104.

Further, the receiving unit 201 registers the previously received information terminal ID and the information terminal specifications transmitted in accordance with the specification transmission command in pair, in the information terminal database 202. Thereby, in the case of subsequent accesses to the information provider apparatus 22 by using the information terminal 21 having this information terminal ID, the information provision apparatus 22 can transmit image data or music data which conform to the specifications of the information terminal without the information terminal specifications of the information terminal 21 being transmitted from the information terminal 21, and can reduce loads on the network, required for transmitting the information terminal specifications from the information terminal 21 to the information provider apparatus 22.

The operation in the following steps S102 to S107 are the same as that of the information provider apparatus 12, which is described in the first embodiment with reference to FIG. 2.

Further, the method for deciding the amount of charges by the charge management unit 105 in the information provider apparatus 22 is also the same as that described in the first embodiment with reference to FIGS. 1, 3 and 4.

As described above, according to the data distribution system of the second embodiment, the information provider apparatus can transmit image data or music data which conform to the specifications of the information terminal, as well as the information terminal can receive image data or music data of an optimum data format. Therefore, excessive data or the like which cannot be reproduced by the information terminal are not transmitted, and further the information provider apparatus decides the amount of charges according to the format of data transmitted to the information terminal, whereby the information user is charged properly.

Further, according to the data distribution system of the second embodiment, the information provider apparatus has the information terminal database, whereby the specifications of the information terminal can be specified by using only the information terminal ID transmitted from the information terminal. Accordingly, when the information terminal accesses the information provider apparatus, the transmission of the information terminal specifications is not required every time, whereby the loads on the network are reduced. Therefore, the latency time required for transmitting the specifications of the information terminal can be eliminated, whereby the information user can obtain necessary information speedily.

[Embodiment 3]

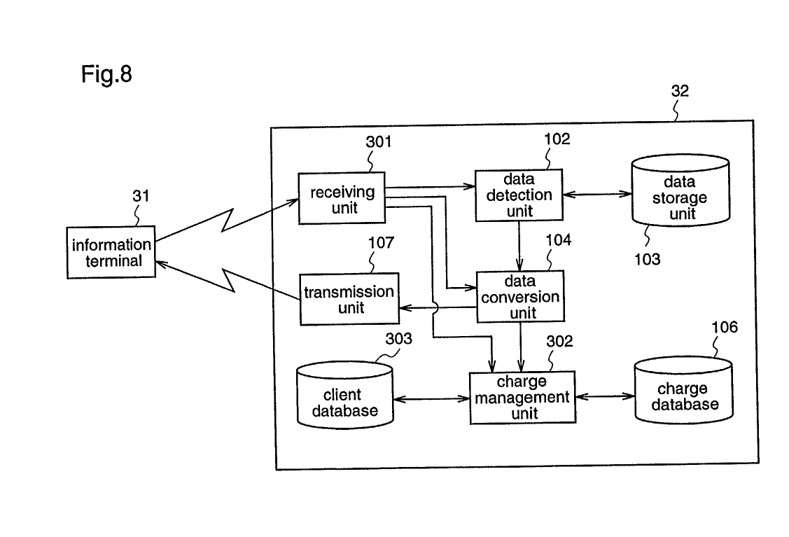

Hereinafter, a data distribution system according to a third embodiment of the present invention will be described with reference to FIGS. 8 to 11.

FIG. 8 is a block diagram illustrating an example of the data distribution system according to the third embodiment. The data distribution system of the third embodiment is different from the above-mentioned data distribution system of the first embodiment only in that a client database 303 for storing and managing utilization histories of information users is included in an information provider apparatus 32, and when an information user is charged, a charge management unit 302 decides the amount of charges on the basis of charge information as information concerning contents of data to be transmitted to an information terminal 31 and utilization history information stored in the client database 303 as the utilization history of the information user, and then charges the information user. The same reference numerals as those in the first embodiment denote the same components.

In FIG. 8, this data distribution system comprises an information terminal 31 used by an information user, and an information provider apparatus 32 which distributes information to the information user.

The information terminal 31 can log on the information provider apparatus 32 via a communication line. The information terminal 31 transmits an information provision request which requests the information provider apparatus 32 to distribute information such as music data or image data, as well as automatically transmits specifications of the information terminal and a client ID for identifying the information user, to the information provider apparatus 32. Further, when the requested information such as image data or music data is distributed from the information provision apparatus 32, the information terminal 31 receives the data.

Here, the communication line includes not only common telephone lines but also various special lines, ISDN lines and the like.

Further, the information terminal specifications represent the format of data requested by the information terminal 31. When still picture information is requested, the specifications include information such as the number of pixels, the tone, the compression ratio, the compression method, the number of reproducible pictures and the storage capacity. When moving picture information is requested, information such as the number of pixels, the tone, the compression ratio, the compression method, the reproduction time and the storage capacity is included. Further, when audio information is requested, information such as the sampling rate, the frequency band, the compression ratio and the compression method is included.

The information terminal specifications and the client IDs are previously stored in a memory (not shown) included in the information terminal, and automatically transmitted to the information provider apparatus 32 at the transmission of an information provision request.

The information provider apparatus 32 comprises a receiving unit 301, a data detection unit 102, a data storage unit 103, a data conversion unit 104, a charge database 106, a transmission unit 107, a charge management unit 302 and a client database 303.

The receiving unit 301 receives an information provision request, specifications of the information terminal, and a client ID, which are transmitted from the information terminal 31, and outputs the information provision request to the data detection unit 102, the information terminal specifications to the data conversion unit 104, and the client ID to the charge management unit 302, respectively.

The charge management unit 302 decides the amount of charges on the basis of utilization history information stored in the client database 302, which is an utilization history of an information user, and charge information which is information outputted from the data conversion unit 104, concerning contents of data to be transmitted to the information terminal 31, such as the type of pre-conversion data, the amount of the data, the format of post-conversion data and the data of utilization, and is information used for deciding the amount of charges, and then collects the amount of charges from the information user who uses the information terminal 31, with using a method such as electronic payment.

Here, the utilization history information is the history of information concerning the charges for the information user, and it may be any information such as the type of provided data, the format of the provided data, the data of utilization and the amount of charges, as long as it is information concerning the charges for the information user.

Further, after charging the information user, the charge management unit 302 registers the information concerning the charges in the client database 303 as the utilization history information of the information user, which is identified by the client ID outputted from the receiving unit 301.

The client database 303 stores and manages client IDs for identifying information users and the charge history information in pair, which are registered by the charge management unit 302.

Next, the operation of the data distribution system will be described.

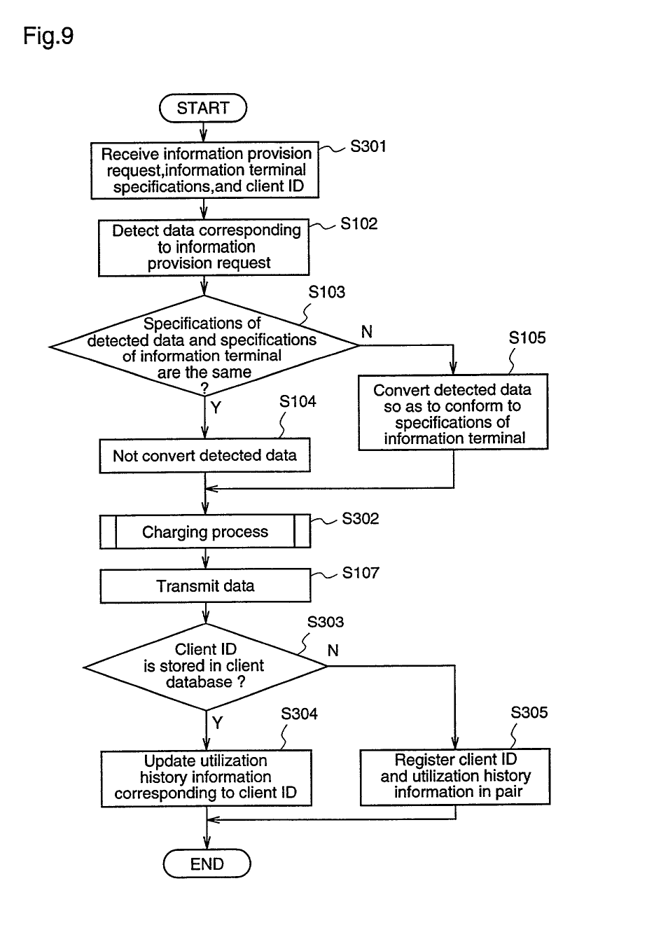

Hereinafter, the operation of the information provider apparatus 32, which is started by transmission of an information provision request, information terminal specifications and a client ID from the information terminal 31, will be described with reference to FIG. 9.

FIG. 9 is a flowchart for illustrating an example of the operation of the information provider apparatus 32 in the data distribution system according to the third embodiment.

The receiving unit 301 receives an information provision request, information terminal specifications, and a client ID from the information terminal 31. At this time, the information provision request transmitted from the information terminal 31 is outputted to the data detection unit 102, the information terminal specifications are outputted to the data conversion unit 104, and the client ID is outputted to the charge management unit 302, respectively.

The data detection unit 102 retrieves data corresponding to the information provision request from the data storage unit 103 on the basis of the information provision request transmitted from the information terminal 31, and outputs the retrieved data corresponding to the information provision request to the data conversion unit 104.

The data conversion unit 104 judges whether the format of the data detected by the data detection unit 102 conforms to the information terminal specifications received by the receiving unit 301, with using the data detected by the data detection unit 102 and the information terminal specifications received by the receiving unit 301. Consequently, when the format conforms to the information terminal specifications the operation proceeds to step S104, and when the format does not conform to the specifications the operation proceeds to step S105.

When the format of the detected data conforms to the information terminal specifications, the data conversion unit 104 outputs the data as it is to the transmission unit 107, as well as outputs charge information, which is information concerning the contents of the data to be transmitted to the information terminal 31, to the charge management unit 302.

When the format of the detected data does not conform to the information terminal specifications, the data conversion unit 104 converts the data into a data format conforming to the information terminal specifications and outputs the converted data to the transmission unit 107, as well as outputs charge information, which is information concerning the contents of the data to be transmitted to the information terminal 31, to the charge management unit 302.

The charge management unit 302 decides the amount of charges on the basis of the charge history information of the information user, which is stored in the client database 303, and the charge information outputted from the data conversion unit 104, and carried out the charging process for collecting the charges from the information user by using a method such as electronic payment. This charging process in step S302 will be described in more detail later.

The transmission unit 107 transmits the data conforming to the information terminal specifications, which is outputted from the data conversion unit 104, to the information terminal 31.

Further, the charge management unit 302 judges whether the client ID outputted from the receiving unit 301 is stored in the client database 303. When the client ID outputted from the receiving unit 301 is stored in the client database 303 the operation proceeds to step S304, and the client ID is not stored in the client database 303 the operation proceeds to step S305.

When the client ID outputted from the receiving unit 301 is stored in the client database 303, the charge management unit 302 appends utilization history information as information concerning the charging which is now performed in step S302, to the utilization history information stored in pair with the client ID, and then ends the processing.

When the client ID outputted from the receiving unit 301 is not stored in the client database 303, the charge management unit 302 stores the utilization history information as information concerning the charging which is performed in step S302 and the client ID in pair, in the client database 303, and then ends the processing.

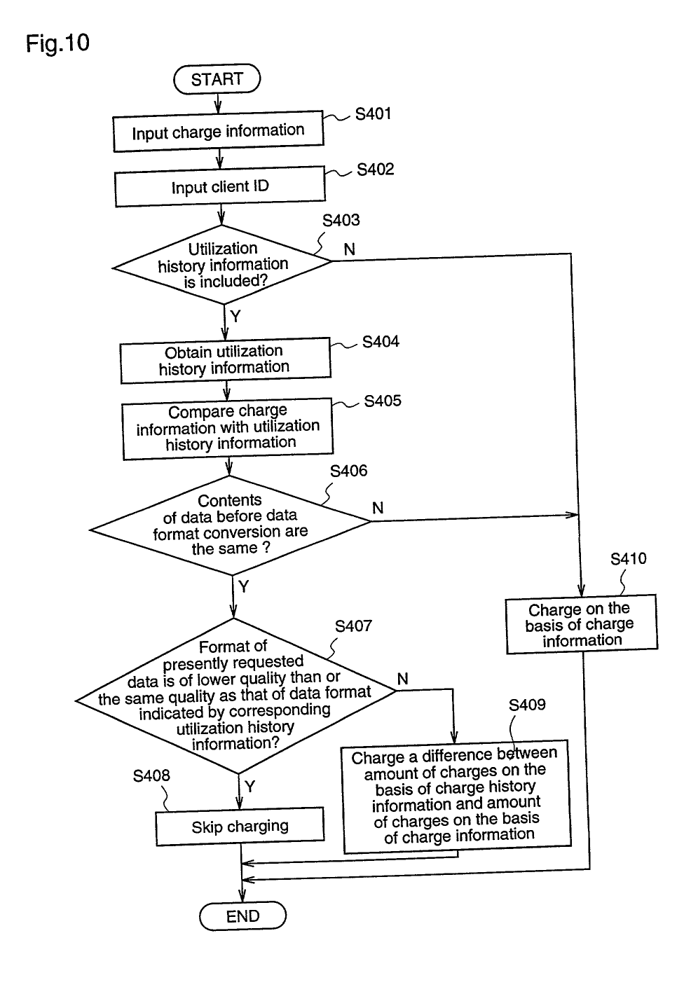

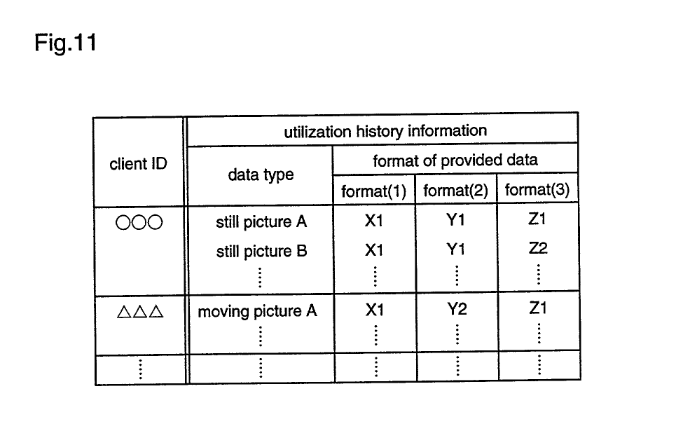

Next, the charging process shown in step S302 in FIG. 9 will be described with reference to FIGS. 10 and 11.

FIG. 10 is a flowchart for explaining an example of the charging process by the charge management unit 302 in the information provider apparatus 32 of the third embodiment.

The charge management unit 302 obtains the charge information outputted from the data conversion unit 104.

The charge management unit 302 obtains the client ID outputted from the receiving unit 301.

The charge management unit 302 checks, by using the client ID obtained in step S402, whether the utilization history information corresponding to this client ID is included in the client database 303. Consequently, when the utilization history information corresponding to the client ID is included, the operation proceeds to step S404. When the utilization history information corresponding to the client ID is not included, the operation proceeds to step S410. FIG. 11 is a diagram showing an example of the client IDs and utilization history information stored in the charge database. As shown in this figure, the client IDs and the utilization history information are registered in pair.

When the utilization history information corresponding to the client ID is included, the charge management unit 302 obtains this utilization history information.

Then, the charge management unit 302 compares the utilization history information obtained in step S404 with the charge information obtained in step S401.

At this time, the charge management unit 302 judges whether the type of presently requested data before data format conversion, which type is indicated by the charge information, is the same as the type of data before data format conversion included in the utilization history information. Consequently, when the type of the presently requested data before data format conversion is the same as that included in the utilization history information, the operation proceeds to step S407. When the types are different, the operation proceeds to step S410.

When the type of the presently requested data before data format conversion is the same as that included in the utilization history information, the charge management unit 302 judges whether or not the format of the presently requested data, which is indicated by the charge information, is of lower quality than or the same quality as that of the format of the data after data format conversion, which is indicated by the corresponding utilization history information. Consequently, when the format of the presently requested data is of lower quality than or the same quality as that of the format of the data indicated by the utilization history information, the operation proceeds to step S408. When the format is of higher quality, the operation proceeds to step S409.

When the format of the presently requested data is of lower quality than or the same quality as that of the data format included in the utilization history information, the charge management unit 302 judges that the information user has already the right to use the presently requested data, and accordingly does not charge the information user.

When the format of the presently requested data is of higher quality than that of the data format included in the utilization history information, the charge management unit 302 charges the information user with a difference between the amounts of charges obtained from the charge data table stored in the charge database 106, which difference results from a difference in the quality of the data, on the basis of the format of this data after conversion included in the charge information and the format of data after conversion included in the utilization history information.

It is judged that this data request by the information user is a request for data which is different from information previously used by the information user, and then the amount of charges is decided using the charge data table stored in the charge database 106 to charge the information user, on the basis of the charge information similarly to the method for deciding the amount of charges as described in the first embodiment.

The charging process which has been described with reference to FIG. 10 is only an example, and any processing can be performed as long as the charge management unit 302 decides the amount of charges on the basis of the utilization history information stored in the client database 303 and the charge information outputted from the data conversion unit 104, and then charges the information user. For example when update data of data which has been already transmitted from the information provider apparatus is transmitted, only differential data from the already transmitted data, which is required for the update data, is transmitted and only the amount of charges for the transmitted differential data is charged.

As described above, according to the data distribution system of the third embodiment, the specifications of the information terminal are automatically transmitted simultaneously with the information provision request to the information provider apparatus. Thereby, the information provider apparatus can transmit image data or music data conforming to the specifications of the information terminal, as well as the information terminal can receive image data or music data of an optimum data format, whereby excessive data of the like which cannot be reproduced by the information terminal are not transmitted. Further, the information provider apparatus decides the amount of charges according to the format of data transmitted to the information terminal, whereby the information user can be properly charged.

Further, according to the data distribution system of the third embodiment, the information provider apparatus includes the client database, whereby the amount of charges can be decided by using the utilization history information as the utilization history of the information user, which is stored in this client database. More particularly, when a client obtains the same image data or music data in different formats by using different information terminals, it is favorable that the client is charged with corresponding optimum charges.

What is claimed is:

1. A data distribution system which comprises an information terminal for requesting distribution of information and an information provider apparatus for providing information to the information terminal, comprising:
the information terminal automatically transmitting specifications of the information terminal when transmitting an information provision request which requests distribution of information; and
the information provider apparatus including: a receiving unit for receiving the information provision request and the information terminal specifications transmitted from the information terminal; a data storage unit for storing and managing various kinds of information data; a data detection unit for detecting data corresponding to the information provision request received by the receiving unit from the data storage unit; a data conversion unit for converting the data detected by the data detection unit so as to conform to the information terminal specifications received by the receiving unit; and a transmission unit for transmitting the data converted by the data conversion unit to the information terminal.

2. A data distribution system which comprises an information terminal for requesting distribution of information and an information provider apparatus for providing information to the information terminal, comprising:
the information terminal automatically transmitting an information terminal ID of the information terminal when transmitting an information provision request which requests distribution of information; and
the information provider apparatus including: an information terminal database for storing and managing the information terminal ID and specifications of the information terminal in pair; a receiving unit for receiving the information provision request and the information terminal ID transmitted from the information terminal and detecting specifications of the information terminal, corresponding to the information terminal ID, from the information terminal database; a data storage unit for storing and managing various kinds of information data; a data detection unit for detecting data corresponding to the information provision request received by the receiving unit from the data storage unit; a data conversion unit for converting the data detected by the data detection unit so as to conform to the information terminal specifications received by the receiving unit; and a transmission unit for transmitting the data converted by the data conversion unit to the information terminal.

3. The data distribution system of claim 1 wherein
the information provider apparatus further includes a charge management unit for deciding an amount of charges according to contents of data transmitted to the information terminal and charging an information user.

4. The data distribution system of claim 2 wherein
the information provider apparatus further includes a charge management unit for deciding an amount of charges according to contents of data transmitted to the information terminal and charging an information user.

5. The data distribution system of claim 3 wherein
the information provider apparatus further includes a client database for storing and managing utilization histories of information users, and
the charge management unit decides an amount of charges according to utilization history of an information user, stored in the client database, and contents of data transmitted to the information terminal, and charges the information user.

6. The data distribution system of claim 4 wherein
the information provider apparatus further includes a client database for storing and managing utilization histories of information users, and
the charge management unit decides an amount of charges according to utilization history of an information user, stored in the client database, and contents of data transmitted to the information terminal, and charges the information user.

7. The data distribution system of any of claims 1 to 6 wherein
when a target for the information provision request transmitted from the information terminal to the information provider apparatus is still picture data, the specifications of the information terminal include information of at least one selected from a number of pixels, a tone, a compression ratio, a compression method, a number of reproducible pictures, and a storage capacity.

8. The data distribution system of any of claims 1 to 6 wherein
when a target for the information provision request transmitted from the information terminal to the information provider apparatus is moving picture data, the specifications of the information terminal include information of at least one selected from a number of pixels, a tone, a compression ratio, a compression method, a reproduction time, and a storage capacity.

9. The data distribution system of any of claims 1 to 6 wherein
when a target for the information provision request transmitted from the information terminal to the information provider apparatus is audio data, the specifications of the information terminal include information of at least one selected from a sampling rate, a frequency band, a compression ratio, a compression method, a reproduction time, and a storage capacity.
